(19) United States
(12) Patent Application Publication
(10) Pub. No.: US 2013/0259387 A1
(43) Pub. Date: Oct. 3, 2013

(54) SYSTEMS AND METHODS FOR LANDMARK DETECTION

(71) Applicant: OTTER CREEK HOLDINGS, LLC, Hooper, UT (US)

(72) Inventors: David Hudson Gunn, Orem, UT (US); Vanessa Brooke Gunn, Orem, UT (US); Robert Brian Moncur, Orem, UT (US)

(73) Assignee: OTTER CREEK HOLDINGS, LLC, Hooper, UT (US)

(21) Appl. No.: 13/763,215

(22) Filed: Feb. 8, 2013

Related U.S. Application Data
(60) Provisional application No. 61/617,652, filed on Mar. 29, 2012.

(51) Int. Cl. G06K 9/62

(52) U.S. Cl. CPC G06K 9/6202
USPC 382/218

(57) ABSTRACT

A computer-implemented method for detecting a landmark. An image is received. A feature in the received image is detected. The detected feature is compared to a plurality of images of landmarks stored in a database. Upon determining the detected feature matches an image of a landmark, information associated with the landmark is retrieved from the database. The retrieved information is displayed on a computing device.

### CROSS-REFERENCE TO RELATED APPLICATION

This application claims the benefit of the filing date of U.S. Provisional Application No. 61/617,652, filed Feb. 17, 2012, and entitled A SYSTEM AND METHOD FOR CAPTURING, IDENTIFYING, CATALOGING, AND DELIVERING INFORMATION, the disclosure of which is incorporated, in its entirety, by reference.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems have opened up multiple modes of communication and increased accessibility to data. The internet allows users to post data, making the posted data available to users on wired and wireless internet connections throughout the world.

One of the multiple modes of communication opened by the internet is the genealogy industry. Genealogy is one of the most searched topics online. Opening the internet to genealogy allows genealogical data to be stored and disseminated online. Users can search census data in online databases for ancestors from around the world. However, the genealogical data generally available online does not enable users to efficiently store and disseminate data from cemeteries and landmarks.

### SUMMARY

According to at least one embodiment, a computer-implemented method for detecting a landmark is described. An image may be received. A feature in the received image may be detected. The detected feature may be compared to a plurality of images of landmarks stored in a database. Upon determining the detected feature matches an image, or meta data, of a landmark, information associated with the landmark may be retrieved from the database. The retrieved information may be displayed on a computing device. In some embodiments, upon determining no match exists between the detected feature and the plurality of images of landmarks, the user may be prompted to enter information regarding the received image. The information entered by the user may be stored in the database for subsequent retrieval.

In one embodiment, upon detecting a portion of text in the received image, an optical character recognition algorithm may be performed to transcribe the detected portion of text. The transcribed portion of text may be compared to one or more entries stored in the database. Upon matching the transcribed portion of text to an entry stored within the database, information associated with the stored entry may be retrieved and the retrieved information may be displayed on the computing device. In some configurations, upon determining no match exists between the transcribed portion of text and the one or more entries, the user may be prompted to enter information regarding the portion of text detected in the received image. The information entered by the user may be stored in the database for subsequent retrieval.

In one embodiment, a user's location may be determined. In some configurations, the determined location may be compared to one or more entries stored in the database. In one embodiment, each entry may relate to one or more landmarks within a predetermined distance of the user's determined location. In some embodiments, upon matching the determined location to an entry stored within the database, information associated with the stored entry may be retrieved and the retrieved information may be displayed on the computing device. Upon determining no match exists between the determined location and the one or more entries, in one embodiment, the user may be prompted to enter information regarding the determined location. Information entered by the user may be stored in the database for subsequent retrieval.

In one embodiment, a user's heading may be determined in relation to the user's determined location. In some configurations, the determined heading may be compared to the one or more entries stored in the database. In some embodiments, upon matching the determined heading to an entry stored within the database, information associated with the stored entry may be retrieved. The retrieved information may be displayed on the computing device. In one embodiment, upon determining no match exists between the determined heading and the one or more entries, the user may be prompted to enter information regarding the determined heading.

A computing device configured to detect a landmark is also described. The device may include a processor and memory in electronic communication with the processor. The memory may store instructions that may be executable by the processor to receive an image, detect a feature in the received image, and compare the detected feature to a plurality of images of landmarks stored in a database. Upon determining the detected feature matches an image of a landmark, the instructions may be executable by the processor to retrieve from the database information associated with the landmark and display the retrieved information on a computing device.

A computer-program product to detect a landmark is also described. The computer-program product may include a non-transitory computer-readable medium that stores instructions. The instructions may be executable by the processor to receive an image, detect a character in the received image, perform an optical character recognition algorithm to transcribe the detected character, and compare the character to one or more entries stored in the database. Upon matching the transcribed portion of text to an entry stored within the database, the instructions may be executable by the processor to retrieve information associated with the stored entry and display the retrieved information on the computing device. In some embodiments, a location and heading of the user may be determined in relation to the received image.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a landmark module;

FIG. 4 is a block diagram illustrating one example of a database module;

FIG. 5 is a block diagram illustrating one example of a detection module;

FIG. 6 is a diagram illustrating an example of a device for capturing an image of a landmark;

FIG. 7 illustrates an example arrangement of detecting a feature in the depicted image of the landmark;

FIG. 8 is a flow diagram illustrating one embodiment of a method for detecting features in images;

FIG. 9 is a flow diagram illustrating one embodiment of a method for detecting a portion of text in images;

FIG. 10 is a flow diagram illustrating one embodiment of a method for determining a user's location in relation to a landmark;

FIG. 11 is a flow diagram illustrating one embodiment of a method for determining a user's heading in relation to a landmark; and

FIG. 12 is a flow diagram illustrating one embodiment of another method for detecting a portion of text in images;

FIG. 13 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to detecting landmarks. Services are provided and information is retrieved and/or created based on the detection of a landmark. Landmarks may include historical landmarks such as the Statue of Liberty, the Golden Gate Bridge, etc. Landmarks may include objects such as historical artifacts, locations such as the site of a historic battle, as well as monuments, memorials, buildings (e.g., the Louvre), natural formations (e.g., the Grand Canyon), grave markers (e.g., headstones), and the like. Based on the determination of an individual's location (e.g., global positioning system (GPS), assisted GPS, cell towers, triangulation, planetary alignment, astrology, longitude-latitude, mapping, etc.), information may be retrieved and/or created in relation to a landmark. Additionally, or alternatively, in some embodiments, based on the determination of an individual's location and heading, information may be retrieved and/or created in relation to a landmark relatively near to the determined location and toward the detected heading. Examples of headings include the direction a user stands when taking a photograph (e.g., facing north), the direction a monument stands (e.g., facing east), and so forth. In some embodiments, based on the processing of an image captured by a user, a feature may be detected in an image of a landmark. Based on the detected landmark, information may be retrieved in relation to the detected landmark. In some embodiments, upon finding no match for the detected landmark, a user may generate information about the landmark and upload the data to a publically available database, making the data available for subsequent retrieval by the user and/or other users.

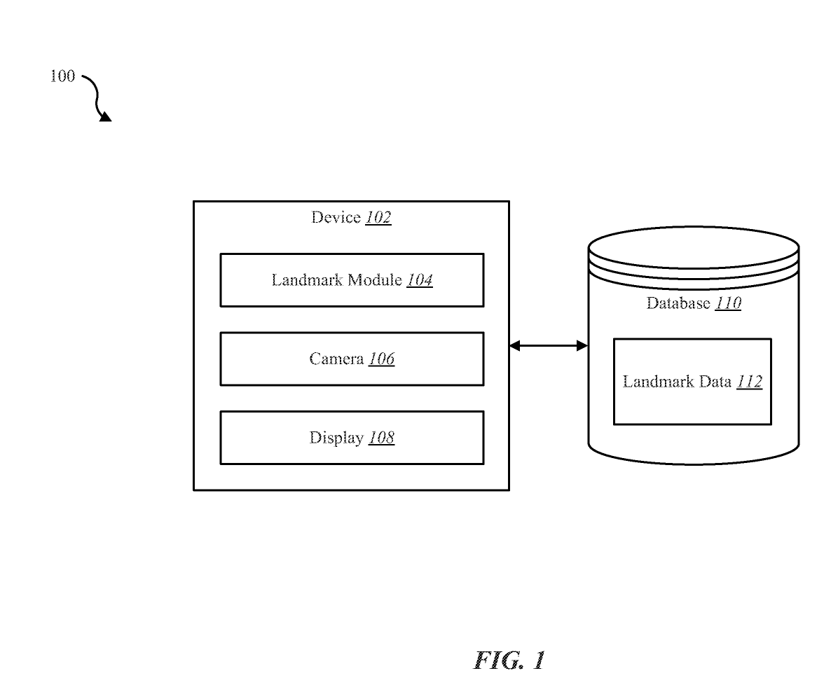

FIG. 1 is a block diagram illustrating one embodiment of an environment 100 in which the present systems and methods may be implemented. In some embodiments, the systems and methods described herein may be performed on a single device (e.g., device 102). For example, a landmark module 104 may be located on the device 102. Examples of devices 102 include mobile devices, smart phones, tablet computing devices, personal computing devices, computers, servers, etc.

In some configurations, a device 102 may include a landmark module 104, a camera 106, and a display 108. In one example, the device 102 may be coupled to a database 110. In one embodiment, the database 110 may be internal to the device 102. In another embodiment, the database 110 may be external to the device 102. In some configurations, the database 110 may include landmark data 112.

In one embodiment, the landmark module 104 may enable the detection of a landmark based on location, heading, and/or image data. In some configurations, the landmark module 104 may obtain one or more images of a landmark. For example, the landmark module 104 may capture an image of a landmark via the camera 106. Additionally, or alternatively, the landmark module 104 may capture a video (e.g., a 5 second video) via the camera 106. The landmark module 104 may process the image to obtain data relating to the image, or image data. In some configurations, the landmark module 104 may query the landmark data 112 in relation to the image data. For example, the landmark module 104 may compare an attribute of the image data to the landmark data 112 in order to determine information regarding the image data. In some embodiments, the landmark module 104 may detect a location and/or heading of the user. For example, the landmark module 104 may detect that the user is standing near the site of the Battle of Antietam in the U.S. Civil War. In some embodiments, the landmark module 104 may detect that the user is heading toward one of the positions of the Union Army during the battle. In response to detecting the location and heading of the user, the landmark module 104 may query the landmark data 112 for a match on the Battle of Antietam. Upon finding a match, the landmark module 104 may display information on the display 108 regarding the battle and the direction the user is positioned and/or headed.

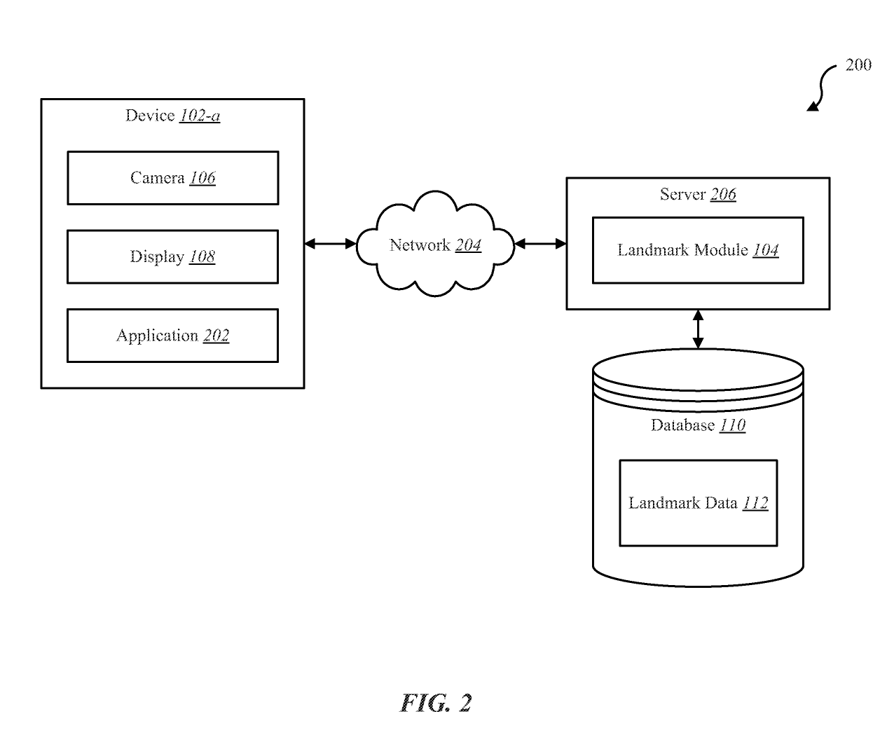

FIG. 2 is a block diagram illustrating another embodiment of an environment 200 in which the present systems and methods may be implemented. In some embodiments, a device 102-a may communicate with a server 206 via a network 204. Example of networks 204 include, local area networks (LAN), wide area networks (WAN), virtual private networks (VPN), wireless networks (using 802.11, for example), cellular networks (using 3G and/or LTE, for example), etc. In some configurations, the network 204 may include the internet. In some configurations, the device 102-a may be one example of the device 102 illustrated in FIG. 1. For example, the device 102-a may include the camera 106, the display 108, and an application 202. It is noted that in some embodiments, the device 102-a may not include a landmark module 104. In some embodiments, both a device 102-a and a server 206 may include a landmark module 104 where at least a portion of the functions of the landmark module 104 may be performed separately and/or concurrently on both the device 102-a and the server 206.

In some embodiments, the server 206 may include the landmark module 104 and may be coupled to the database 110. For example, the landmark module 104 may access the landmark data 112 in the database 110 via the server 206. The database 110 may be internal or external to the server 206. In some embodiments, the database 110 may be accessible by the device 102-a and/or the server 206 over the network 204.

In some configurations, the application 202 may capture multiple images via the camera 106. For example, the application 202 may use the camera 106 to capture a video. Upon capturing the multiple images, the application 202 may process the multiple images to generate image data. In some embodiments, the application 202 may transmit one or more images to the server 206. Additionally or alternatively, the application 202 may transmit to the server 206 the image data or at least one file associated with the image data.

In some configurations, the landmark module 104 may process one or more images of a landmark to detect features in the image relating to the landmark, and determine whether the landmark data 112 contains information regarding the detected landmark. In some embodiments, the application 202 may process one or more images captured by the camera 106 in order to allow the user to enter information regarding the image.

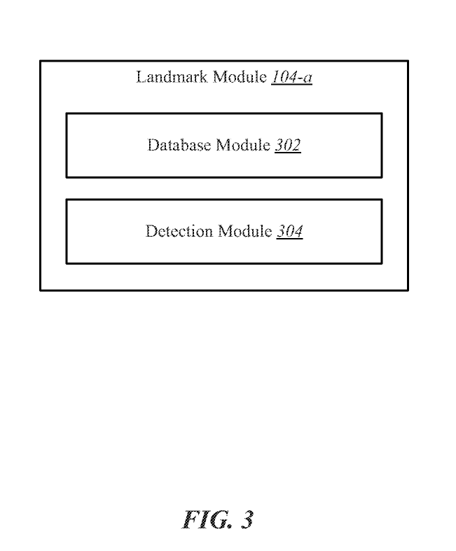

FIG. 3 is a block diagram illustrating one example of a landmark module 104-a. The landmark module 104-a may be one example of the landmark module 104 depicted in FIGS. 1 and/or 2. As depicted, the landmark module 104-a may include a detection module 304 and a database module 302.

In some configurations, the detection module 304 may detect one or more features in relation to an image. Additionally, or alternatively, the detection module 304 may detect a user's location and/or heading. In some embodiments, the data detected by the detection module 304 may enable the landmark module 104-a to detect a landmark. In some embodiments, the detection module 304 may detect a landmark based on a user's location and/or heading. In some embodiments, the detection module 304 may detect a landmark based on an image of a landmark. Upon detecting the landmark, the database module 302 may query a database for information about the detected landmark. Upon matching the detected landmark to one or more entries in the database, the database module 302 may retrieve and display the information contained in the one or more entries of the database on a computing device, such as the display 108 of the device 102 depicted in FIGS. 1 and/or 2. Upon finding no match for the detected landmark, and/or not detecting a landmark, the database module 302 may prompt the user to enter data regarding the location and/or heading of the user. Additionally, or alternatively, the database module 302 may prompt the user to enter data regarding the content of an image. For example, the user may enter the location (e.g., coordinates, city, county, state, province, country, etc.), heading, title, description, and the like, regarding an image. In some embodiments, the database module 302 may store the image and/or the data entered by the user in the landmark data 112.

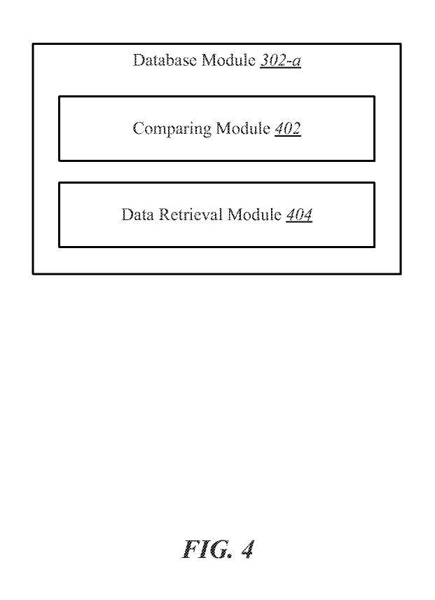

FIG. 4 is a block diagram illustrating one example of a database module 302-a. The database module 302-a may be one example of the database module 302 illustrated in FIG. 3. As depicted, the database module 302-a may include a comparing module 402 and a data retrieval module 404.

In some embodiments, the comparing module 402 may compare a feature detected by the detection module 304 to an entry in the database 110. For example, the comparing module 402 may query the landmark data 112 to compare at least a portion of the landmark data 112 to a feature (e.g., location, heading, image data, etc.) detected by the detection module 304. Upon determining the detected feature matches an entry in the database 110, the data retrieval module 404 may retrieve from the database 110 information associated with the entry stored in the database. For example, upon the detection module 304 determining the location of a user is in the vicinity of the Golden Gate Bridge, the data retrieval module 404 may retrieve information about the Golden Gate Bridge stored in the database 110. The data retrieval module 404 may then display the information on the screen of a computing device, such as the display 108 of the device 102 depicted in FIGS. 1 and/or 2.

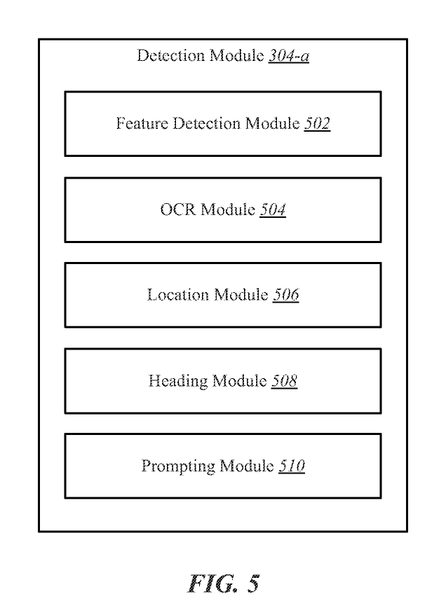

FIG. 5 is a block diagram illustrating one example of a detection module 304-a. The detection module 304-a may be one example of the detection module 304 illustrated in FIG. 3. As depicted, the detection module 304 may include a feature detection module 502, an optical character recognition (OCR) module 504, a location module 506, a heading module 508, and a prompting module 510.

In one embodiment, the feature detection module 502 may detect a feature in an image. In some embodiments, the feature detection module 502 may receive an image and detect a feature in the received image. In some embodiments, the features detection module 502 may detect a color, a gamma scale, encoded and/or compressed information (e.g., gzip), text fields, hidden and/or non-visible colors, shapes, gradients, texts, symbols, identifiers (e.g., tag, barcode, etc.), and the like. In some embodiments, the feature detection module 502 may detect an edge, corner, interest point, blob, and/or ridge in an image of a landmark. An edge may be points of an image where there is a boundary (or an edge) between two image regions, or a set of points in the image which have a relatively strong gradient magnitude. Corners and interest points may be used interchangeably. An interest point may refer to a point-like feature in an image, which has a local two dimensional structure. In some embodiments, the feature detection module 304 may search for relatively high levels of curvature in an image gradient to detect an interest point and/or corner (e.g., corner of a building, corner of a monument). Thus, the feature detection module 304 may detect in an image of the Washington Monument such features as the color, edge, obelisk shape, etc. A blob may include a complementary description of image structures in terms of regions, as opposed to corners that may be point-like in comparison. Thus, in some embodiments, the feature detection module 304 may detect a smooth, non-point-like area (i.e., blob) in an image. Additionally, or alternatively, in some embodiments, the feature detection module 304 may detect a ridge of points in the image. In some embodiments, the feature detection module 304 may extract a local image patch around a detected feature in order to track the feature in other images.

In some embodiments, the comparing module 402 may compare the feature detected by the feature detection module 502 to a plurality of images of landmarks stored in the database 110. Upon determining the detected feature matches an image of a landmark stored in the database 110, the data retrieval module 404 retrieve from the database information associated with the landmark and display the retrieved information on a computing device. Upon determining no match exists between the detected feature and the plurality of images of landmarks stored in the database 110, the prompting module 510 may prompt the user to enter information relating to the received image. The database module 302 may store the information entered by the user in the database 110 for subsequent retrieval by the user or one or more other users. For example, a first user may take a photograph of a castle in England. Upon determining the image of the castle does not match any entry in the database 110, the prompting module 510 may prompt the first user to enter information regarding the photo, such as a title, a location (e.g., coordinates, city, county, state, province, country, etc.), a description, heading, and so forth. The database module 302 may store the information (and in some embodiments, the photo) to the database 110. Subsequently, a second user visiting the same castle may take a photo of the castle. The feature detection module 502 may detect a feature of the image (e.g., shape, color, edge, interest point, etc.) that, when compared to the previous image of the castle stored in the database 110, triggers a match by the comparing module 402. The data retrieval module 404 may retrieve the information previously entered by the first user and display the information to the second user. Additionally, or alternatively, the feature detection module 502 may detect a feature of an image in relation to a determination of a user's location via the location module 506 and/or a determination of a user's heading via the heading module 506.

In some configurations, the OCR module 504 may convert an image of text into text characters. In some embodiments, upon the feature detection module 502 detecting a portion of text in the received image, the OCR module 504 may perform an optical character recognition algorithm to transcribe the detected portion of text. The database module 302 may store the transcribed text in the landmark data 112 for subsequent retrieval.

In some embodiments, the comparing module 402 may compare the transcribed portion of text to one or more entries stored in the database 110. Upon matching the transcribed portion of text to an entry stored within the database 110, the data retrieval module 404 may retrieve information associated with the stored entry for display on a computing device. In some embodiments, upon determining no match exists between the transcribed portion of text and the one or more entries of the database 110, the prompting module 510 may prompt the user to enter information regarding the portion of text detected in the received image. For example, the prompting module 510 may prompt the user to confirm that the OCR module 504 correctly transcribes the detected portion of text.

In some embodiments, the location module 506 may determine a user's location. The location of the user may be determined by GPS, assisted GPS, cell towers, triangulation, planetary alignment, astrology, longitude-latitude, mapping, and the like. In some embodiments, the comparing module 402 may compare the determined location to one or more entries stored in the database. In some configurations, each entry relates to one or more landmarks within a predetermined distance of the user's determined location. Upon matching the determined location to an entry stored within the database 110, the data retrieval module 510 may retrieve information associated with the stored entry for display on a computing device. In some embodiments, upon determining no match exists between the determined location and the one or more entries, the prompting module 510 may prompt the user to enter information regarding the determined location. The database module 302 may be configured to store the information entered by the user in the database 110 for subsequent retrieval by the user and/or other users.

In one embodiment, the heading module 508 may determine a user's heading in relation to the location of the user determined by the location module 506. In some embodiments, the comparing module 402 may compare the determined heading to one or more entries stored in the database 110. Upon matching the determined heading of the user to an entry stored within the database 110, the data retrieval module 404 may retrieve information associated with the stored entry for display on a computing device. In some embodiments, upon determining no match exists between the determined heading and the one or more entries stored in the database 110, the prompting module 510 may prompt the user to enter information regarding the determined heading. In some embodiments, the prompting module 510 may prompt the user to enter a heading in relation to the point of view of an image. For instance, a user may be facing south when the user takes an image. The user may then enter “south,” and the database module 302 may store the image and the entered heading of the image in the database 110.

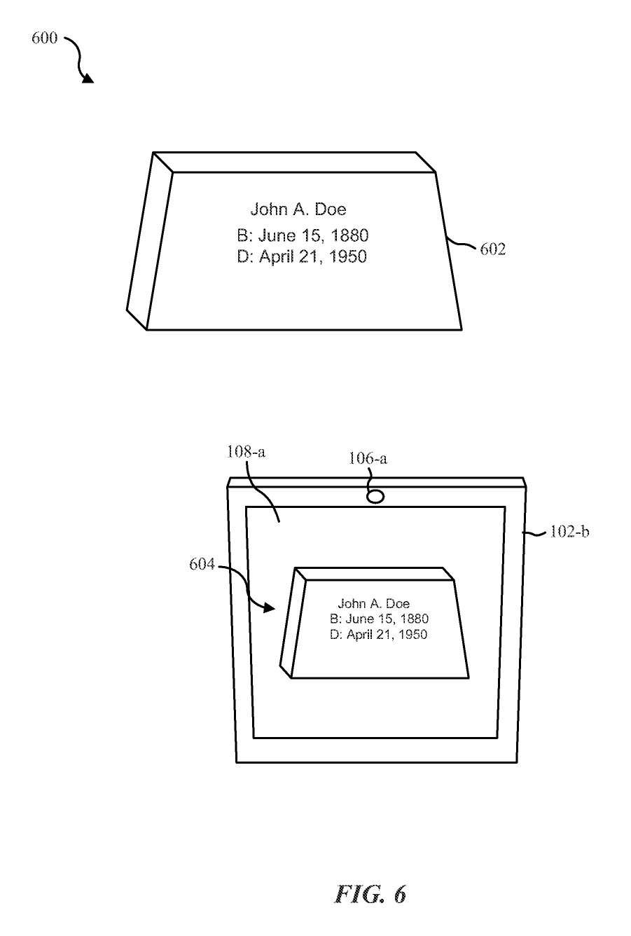

FIG. 6 is a diagram 600 illustrating an example of a device 102-b for capturing an image 604 of a landmark 602. The device 102-b may be one example of the device 102 illustrated in FIGS. 1 and/or 2. As depicted, the device 102-b may include a camera 106-a, and display 108-a. The camera 106-a and display 108-a may be examples of the respective camera 106 and display 108 illustrated in FIGS. 1 and/or 2.

In one embodiment, the user may operate the device 102-b. For example, the application 202 may allow the user to interact with and/or operate the device 102-b. In one embodiment, the camera 106-a may allow the user to capture an image 604 of the landmark 602. As depicted, the landmark 602 may include a headstone. Thus, upon the user capturing the image 604 of the headstone 602, the landmark module 104 may perform feature detection in relation to the image 604 to detect one or more features of the image. Additionally, the landmark module 104 may detect a location and/or heading in association with the captured image.

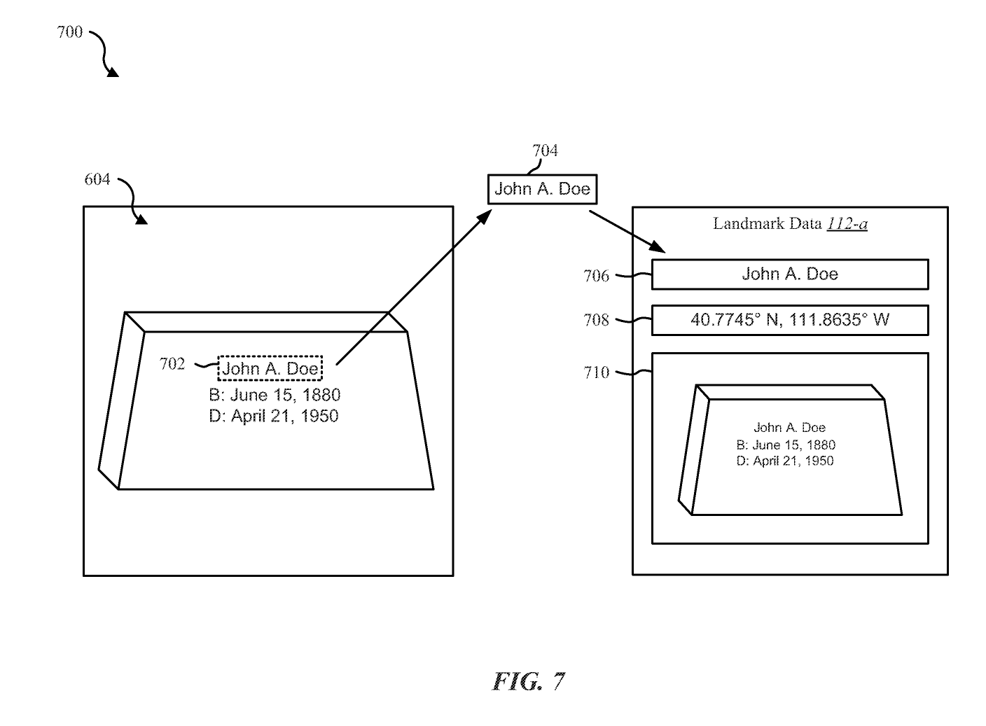

FIG. 7 illustrates an example arrangement 700 of a feature 702 detected in the depicted image 604 of the landmark 602 of FIG. 6. As depicted, the example arrangement 700 may include the image 604 of the landmark 602, an extracted feature 704, and landmark data 112-a. The landmark data 112-a may be one example of the landmark data 112 depicted in FIGS. 1 and/or 2. In some embodiments, the feature detection module 502 may detect a feature of the image 604. For example, as depicted, the feature detection module 502 may detect text in the image. As depicted, the text may include information relating to a headstone. In other examples, the image 604 may include text from a sign, a document, a monument, a book, and the like. In some embodiments, the OCR module 504 may transcribe the detected text into text characters to generate the extracted feature 704. With the text extracted from the image, the comparing module 402 may compare the extracted feature 704 to one or more entries in the landmark data 112-a. As depicted, at least one entry among the landmark data 112-a may include a match to the extracted feature 704. In some embodiments, the landmark data 112-a may include information related to a headstone in a cemetery. For example, the landmark data 112-a may include name data 706, location data 708, and image data 710. In some embodiments, the location data 708 may include heading data. For example, the depicted record in the landmark data 112-a may include heading data relating the direction that the headstone faces and/or the direction from which the image data 710 was captured (e.g., facing east). Upon finding the match, the data retrieval module 404 may retrieve the matching record from the landmark data 112-a and display one or more elements from the matching record on a computing device, such as the display 108 of the device 102 depicted in FIGS. 1 and/or 2.

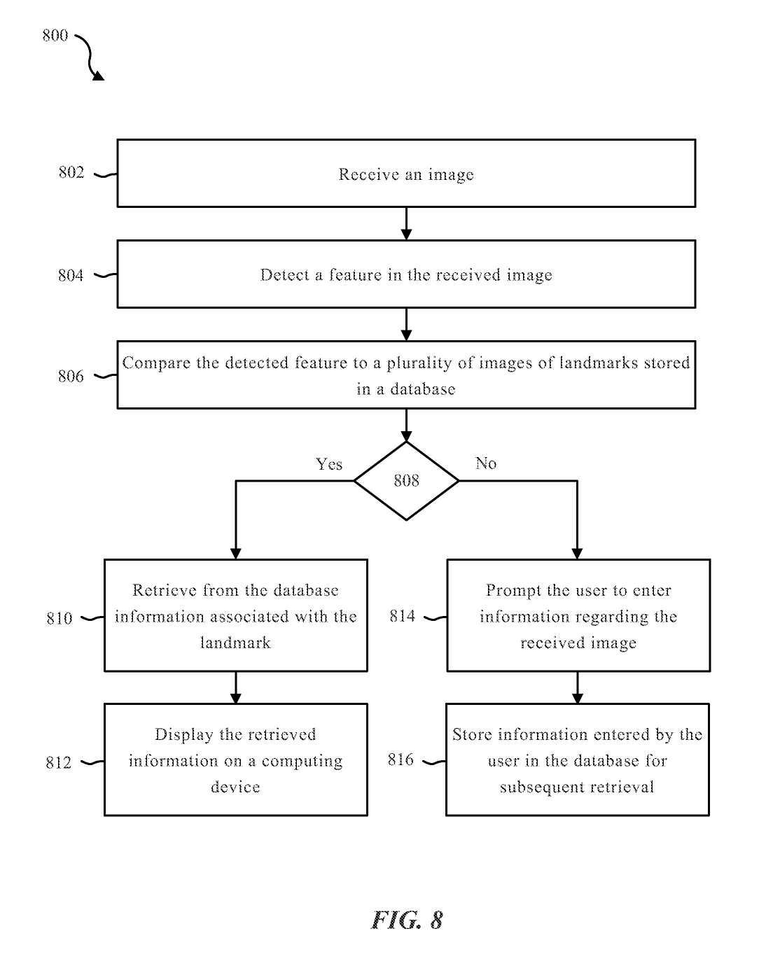

FIG. 8 is a flow diagram illustrating one embodiment of a method 800 for detecting features in images. In some configurations, the method 800 may be implemented by the landmark module 104 illustrated in FIGS. 1, 2, and/or 3. In some configurations, the method 800 may be implemented by the application 202 illustrated in FIG. 2.

At block 802, an image may be received. In some embodiments, a user may capture the image. Additionally, or alternatively, the image may be sent in an email or text message, downloaded (e.g., from the internet), uploaded (e.g., to the internet), and/or retrieved from a storage device (e.g., local hard drive). At block 804, a feature may be detected in the received image.

At block 806, the detected feature may be compared to one or more images of landmarks stored in a database (e.g., database 110). At block 808, a determination is made as to whether the feature detected in the received image matches at least a portion of the one or more images of landmarks stored in the database. At block 810, upon determining the detected feature matches at least one image of a landmark, information may be retrieved from the database that is associated with the landmark depicted in the one or more matching images. At block 812, the retrieved information may be displayed on a computing device.

At block 814, upon determining that the one or more images of landmarks do not match the detected feature, the user may be prompted to enter information regarding the received image. At block 816, the information entered by the user may be stored in the database for subsequent retrieval.

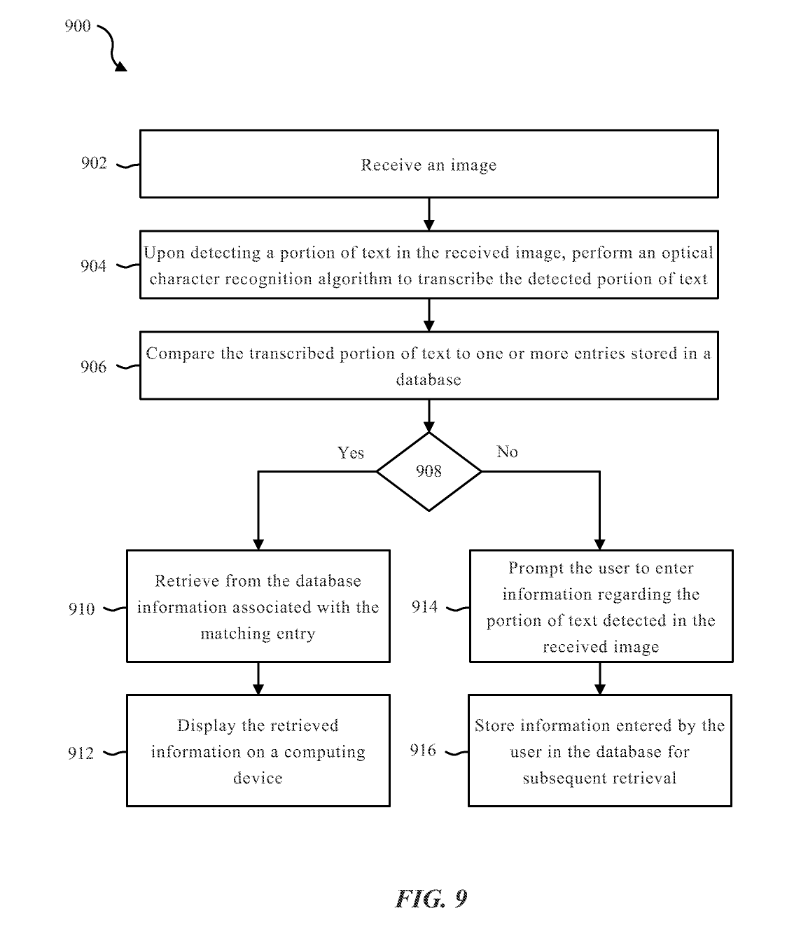

FIG. 9 is a flow diagram illustrating one embodiment of a method 900 for detecting a portion of text in images. In some configurations, the method 900 may be implemented by the landmark module 104 illustrated in FIGS. 1, 2, and/or 3. In some configurations, the method 900 may be implemented by the application 202 illustrated in FIG. 2.

At block 902, an image may be received. At block 904, upon detecting a portion of text in the received image, an OCR algorithm may be performed to transcribe the detected portion of text in the image into text characters.

At block 906, the transcribed portion of text may be compared to one or more entries stored in a database. At block 908, a determination is made as to whether the transcribed portion of text matches at least a portion of the one or more entries stored in the database. At block 910, upon determining the transcribed portion of text matches a portion of at least one entry, information may be retrieved from the database associated with the matching portion of text. At block 912, the retrieved information may be displayed on a computing device (e.g., the display 108 of the device 102 depicted in FIGS. 1 and/or 2).

At block 914, upon determining that the one or more entries do not match the transcribed portion of text, the user may be prompted to enter information regarding the portion of text detected in the received image. At block 916, the information entered by the user may be stored in the database for subsequent retrieval.

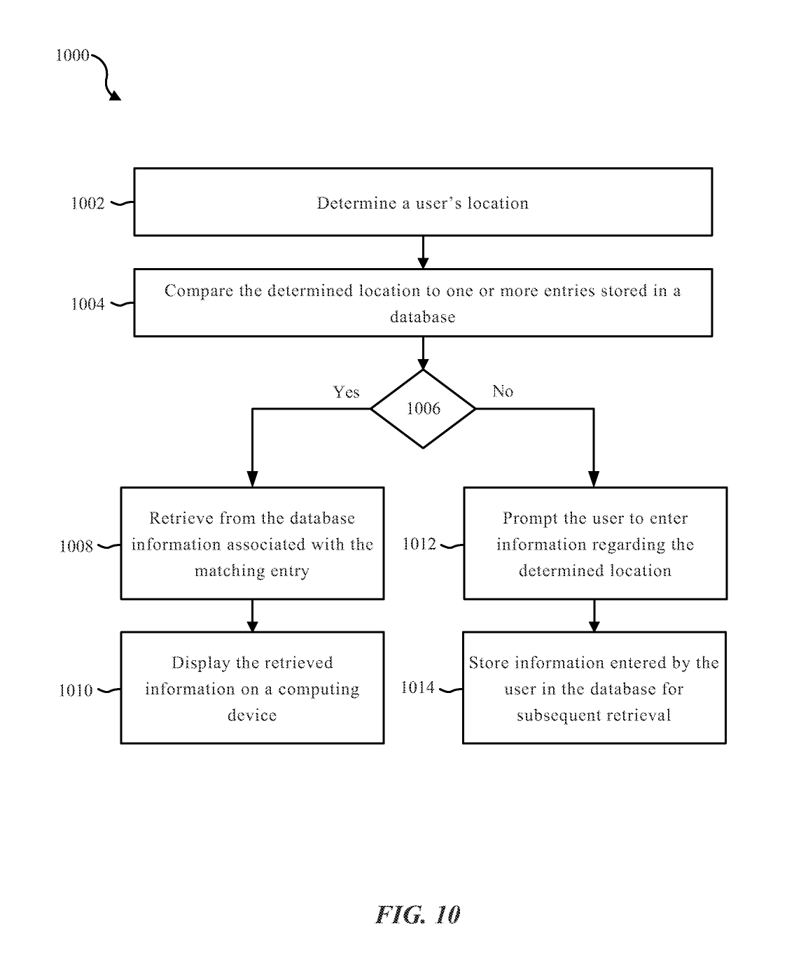

FIG. 10 is a flow diagram illustrating one embodiment of a method 1000 for determining a user's location in relation to a landmark. In some configurations, the method 1000 may be implemented by the landmark module 104 illustrated in FIGS. 1, 2, and/or 3. In some configurations, the method 1000 may be implemented by the application 202 illustrated in FIG. 2.

At block 1002, a user's location may be determined. In some embodiments, the user's location is determined in relation to the user capturing an image (e.g., an image of a landmark). At block 1004, the determined location may be compared to one or more entries stored in a database. At block 1006, a determination is made as to whether the determined location matches at least a portion of the one or more entries stored in the database. At block 1008, upon determining the determined location matches a portion of at least one entry, information may be retrieved from the database associated with the one or more matching entries. At block 1010, the retrieved information may be displayed on a computing device.

At block 1012, upon determining that no portion of the one or more entries matches the determined location, the user may be prompted to enter information regarding the determined location. At block 1014, the information entered by the user may be stored in the database for subsequent retrieval.

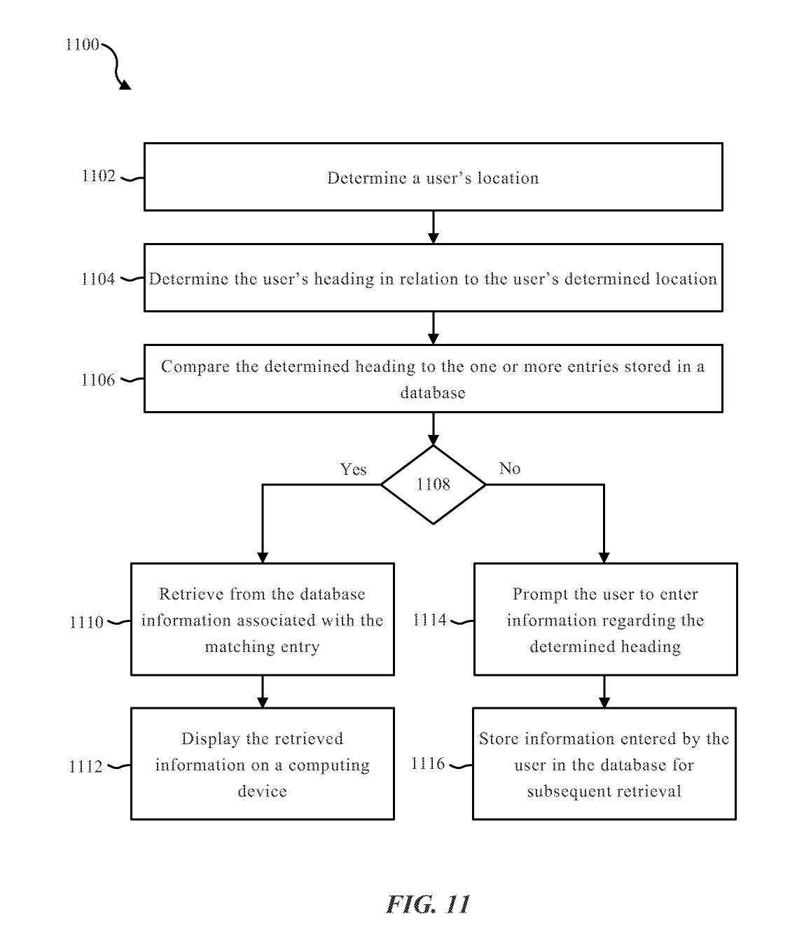

FIG. 11 is a flow diagram illustrating one embodiment of a method 1100 for determining a user's heading in relation to a landmark. In some configurations, the method 1100 may be implemented by the landmark module 104 illustrated in FIGS. 1, 2, and/or 3. In some configurations, the method 1100 may be implemented by the application 202 illustrated in FIG. 2.

At block 1102, an user's location may be determined. At block 1104, the user's heading may be determined in relation to the determined location of the user. At block 1106, the determined heading may be compared to one or more entries stored in a database.

At block 1108, a determination is made as to whether determined heading matches at least a portion of the one or more entries stored in the database. At block 1110, upon determining the determined heading matches a portion of at least one entry, information may be retrieved from the database associated with the one or more matching entries. At block 1112, the retrieved information may be displayed on a computing device.

At block 1114, upon determining that the one or more entries do not match the determined heading, the user may be prompted to enter information regarding the detected heading. At block 1116, the information entered by the user may be stored in the database for subsequent retrieval.

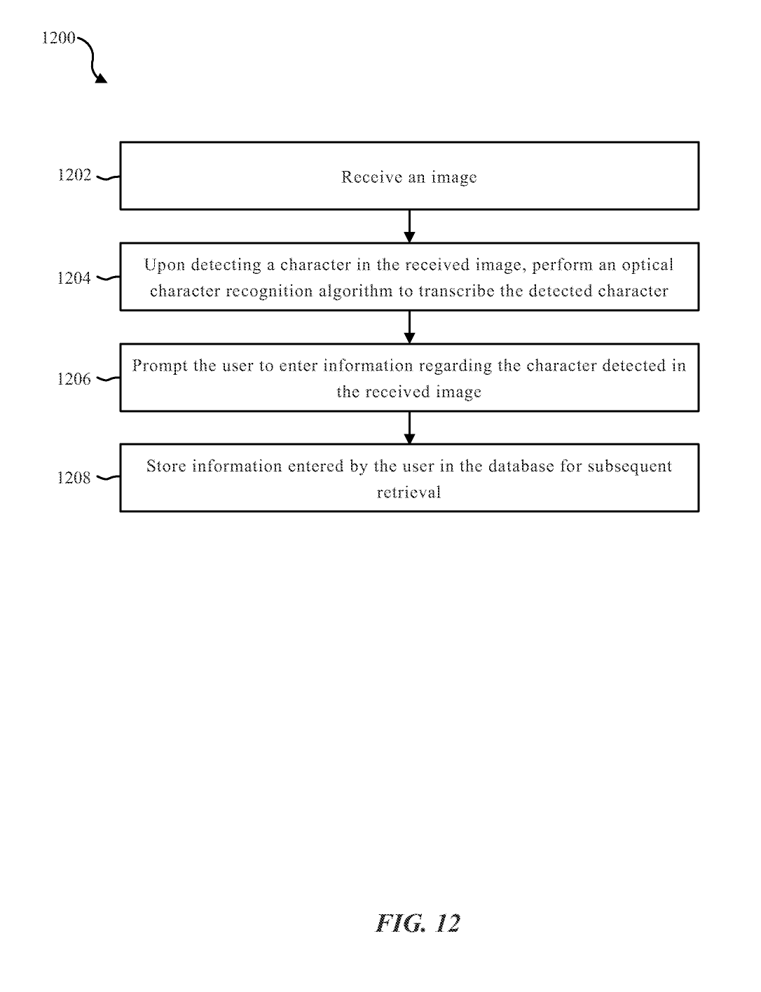

FIG. 12 is a flow diagram illustrating one embodiment of a method 1200 for detecting a character in images. In some configurations, the method 1200 may be implemented by the landmark module 104 illustrated in FIGS. 1, 2, and/or 3. In some configurations, the method 1200 may be implemented by the application 202 illustrated in FIG. 2.

At block 1202, an image may be received. At block 1204, upon detecting a character in the received image, an OCR algorithm may be performed to transcribe the detected character in the image into text characters.

At block 1206, the user may be prompted to enter information regarding the character detected in the received image. At block 1208, the information entered by the user may be stored in the database for subsequent retrieval.

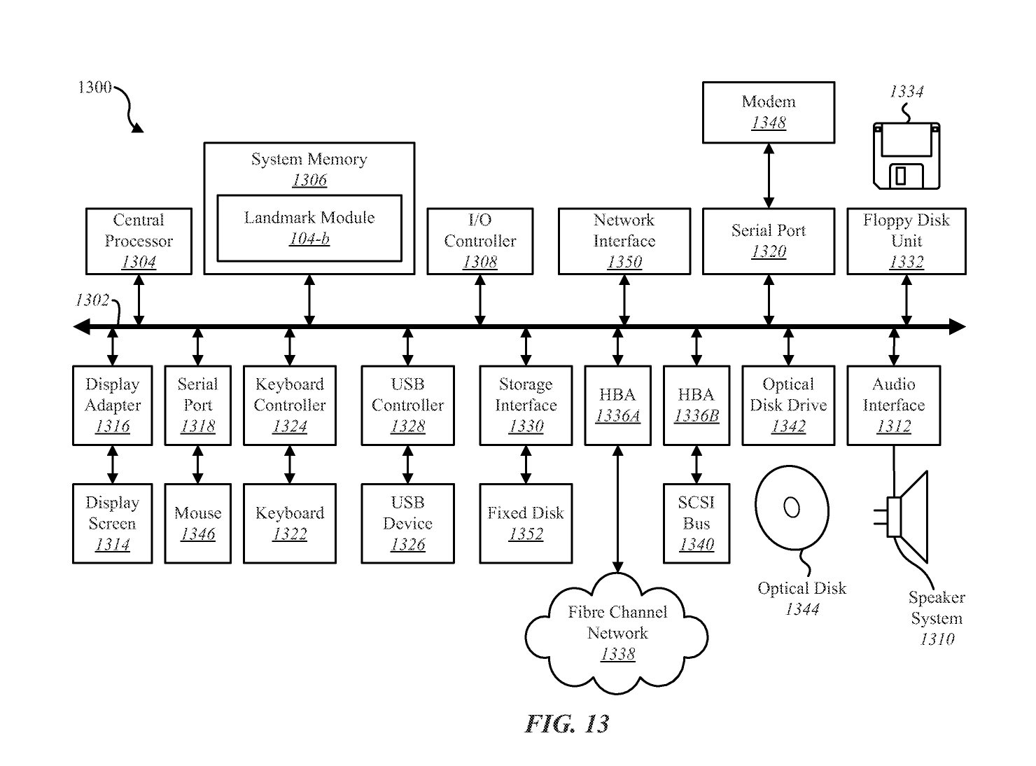

FIG. 13 depicts a block diagram of a computer system 1300 suitable for implementing the present systems and methods. The depicted computer system 1300 may be one example of a server 206 depicted in FIG. 2. Alternatively, the system 1300 may be one example of a device 102 depicted in FIGS. 1, 2, and/or 6. Computer system 1300 includes a bus 1302 which interconnects major subsystems of computer system 1300, such as a central processor 1304, a system memory 1306 (typically RAM, but which may also include ROM, flash RAM, or the like), an input/output controller 1308, an external audio device, such as a speaker system 1310 via an audio output interface 1312, an external device, such as a display screen 1314 via display adapter 1316, serial ports 1318 and mouse 1346, a keyboard 1322 (interfaced with a keyboard controller 1324), multiple USB devices 1326 (interfaced with a USB controller 1328), a storage interface 1330, a host bus adapter (HBA) interface card 1336A operative to connect with a Fibre Channel network 1338, a host bus adapter (HBA) interface card 1336B operative to connect to a SCSI bus 1340, and an optical disk drive 1342 operative to receive an optical disk 1344. Also included are a mouse 1346 (or other point-and-click device, coupled to bus 1302 via serial port 1318), a modem 1348 (coupled to bus 1302 via serial port 1320), and a network interface 1350 (coupled directly to bus 1302).

Bus 1302 allows data communication between central processor 1304 and system memory 1306, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, a landmark module 104-b to implement the present systems and methods may be stored within the system memory 1306. The landmark module 104-b may be one example of the landmark module 104 depicted in FIGS. 1, 2, and/or 3. Applications resident with computer system 1300 are generally stored on and accessed via a non-transitory computer readable medium, such as a hard disk drive (e.g., fixed disk 1352), an optical drive (e.g., optical drive 1342), or other storage medium. Additionally, applications can be in the form of electronic signals modulated in accordance with the application and data communication technology when accessed via network modem 1348 or interface 1350.

Storage interface 1330, as with the other storage interfaces of computer system 1300, can connect to a standard computer readable medium for storage and/or retrieval of information, such as a fixed disk drive 1352. Fixed disk drive 1352 may be a part of computer system 1300 or may be separate and accessed through other interface systems. Modem 1348 may provide a direct connection to a remote server via a telephone link or to the Internet via an internet service provider (ISP). Network interface 1350 may provide a direct connection to a remote server via a direct network link to the Internet via a POP (point of presence). Network interface 1350 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 13 need not be present to practice the present systems and methods. The devices and subsystems can be interconnected in different ways from that shown in FIG. 13. The operation of at least some of the computer system 1300 such as that shown in FIG. 13 is readily known in the art and is not discussed in detail in this application. Code to implement the present disclosure can be stored in a non-transitory computer-readable medium such as one or more of system memory 1306, fixed disk 1352, or optical disk 1344. The operating system provided on computer system 1300 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for detecting a landmark, the method comprising:
receiving an image;
detecting a feature in the received image;
comparing the detected feature to a plurality of images of landmarks stored in a database;
upon determining the detected feature matches an image of a landmark, retrieving from the database information associated with the landmark; and
displaying the retrieved information on a computing device.

2. The method of claim 1, further comprising:
upon determining no match exists between the detected feature and the plurality of images of landmarks, prompting the user to enter information regarding the received image; and
storing information entered by the user in the database for subsequent retrieval.

3. The method of claim 1, further comprising:
upon detecting a portion of text in the received image, performing an optical character recognition algorithm to transcribe the detected portion of text;
comparing the transcribed portion of text to one or more entries stored in the database;
upon matching the transcribed portion of text to an entry stored within the database, retrieving information associated with the stored entry; and
displaying the retrieved information on the computing device.

4. The method of claim 3, further comprising:
upon determining no match exists between the transcribed portion of text and the one or more entries, prompting the user to enter information regarding the portion of text detected in the received image;
storing information entered by the user in the database for subsequent retrieval.

5. The method of claim 1, further comprising:
determining a user's location;
comparing the determined location to one or more entries stored in the database, wherein each entry relates to one or more landmarks within a predetermined distance of the user's determined location;
upon matching the determined location to an entry stored within the database, retrieving information associated with the stored entry; and
displaying the retrieved information on the computing device.

6. The method of claim 5, further comprising:
upon determining no match exists between the determined location and the one or more entries, prompting the user to enter information regarding the determined location;
storing information entered by the user in the database for subsequent retrieval.

7. The method of claim 5, further comprising:
determining a user's heading in relation to the user's determined location;
comparing the determined heading to the one or more entries stored in the database;
upon matching the determined heading to an entry stored within the database, retrieving information associated with the stored entry; and
displaying the retrieved information on the computing device.

8. The method of claim 7, further comprising:
upon determining no match exists between the determined heading and the one or more entries, prompting the user to enter information regarding the determined heading; and
storing information entered by the user in the database for subsequent retrieval.

9. A computing device configured to detect a landmark, comprising:
a processor;
memory in electronic communication with the processor;
instructions stored in the memory, the instructions being executable by the processor to:
receive an image;
detect a feature in the received image;
compare the detected feature to a plurality of images of landmarks stored in a database;
upon determining the detected feature matches an image of a landmark, retrieve from the database information associated with the landmark; and
display the retrieved information on a computing device.

10. The computing device of claim 9, wherein the instructions are executable by the processor to:
upon determining no match exists between the detected feature and the plurality of images of landmarks, prompt the user to enter information regarding the received image; and
store information entered by the user in the database for subsequent retrieval.

11. The computing device of claim 9, wherein the instructions are executable by the processor to:
upon detecting a portion of text in the received image, perform an optical character recognition algorithm to transcribe the detected portion of text;
compare the transcribed portion of text to one or more entries stored in the database;
upon matching the transcribed portion of text to an entry stored within the database, retrieve information associated with the stored entry; and
display the retrieved information on the computing device.

12. The computing device of claim 11, wherein the instructions are executable by the processor to:
upon determining no match exists between the transcribed portion of text and the one or more entries, prompt the user to enter information regarding the portion of text detected in the received image;
store information entered by the user in the database for subsequent retrieval.

13. The computing device of claim 9, wherein the instructions are executable by the processor to:
determine a user's location;
compare the determined location to one or more entries stored in the database, wherein each entry relates to one or more landmarks within a predetermined distance of the user's determined location;
upon matching the determined location to an entry stored within the database, retrieve information associated with the stored entry; and
display the retrieved information on the computing device.

14. The computing device of claim 13, wherein the instructions are executable by the processor to:
upon determining no match exists between the determined location and the one or more entries, prompt the user to enter information regarding the determined location;
store information entered by the user in the database for subsequent retrieval.

15. The computing device of claim 13, wherein the instructions are executable by the processor to:
determine a user's heading in relation to the user's determined location;
compare the determined heading to the one or more entries stored in the database;
upon matching the determined heading to an entry stored within the database, retrieve information associated with the stored entry; and
display the retrieved information on the computing device.

16. The computing device of claim 15, wherein the instructions are executable by the processor to:
upon determining no match exists between the determined heading and the one or more entries, prompt the user to enter information regarding the determined heading; and
store information entered by the user in the database for subsequent retrieval.

17. A computer-program product for detecting, by a processor, a landmark, the computer-program product comprising a non-transitory computer-readable medium storing instructions thereon, the instructions being executable by the processor to:
receive an image;
detect a character in the received image;
perform an optical character recognition algorithm to transcribe the detected character;
compare the character to one or more entries stored in the database;
upon matching the transcribed character to an entry stored within the database, retrieve information associated with the stored entry; and
display the retrieved information on a computing device.

18. The computer-program product of claim 17, wherein the instructions are executable by the processor to:
determine a user's location;
compare the determined location to one or more entries stored in the database, wherein each entry relates to one or more landmarks within a predetermined distance of the user's determined location;
upon matching the determined location to an entry stored within the database, retrieve information associated with the stored entry; and
display the retrieved information on the computing device.

19. The computer-program product of claim 18, wherein the instructions are executable by the processor to:
determine a user's heading in relation to the user's determined location;
compare the determined heading to the one or more entries stored in the database;
upon matching the determined heading to an entry stored within the database, retrieve information associated with the stored entry; and
display the retrieved information on the computing device.

20. The computer-program product of claim 19, wherein the location and heading of the user are determined in relation to the received image.
